(19) United States
(12) Patent Application Publication
(10) Pub. No.: US 2015/0223401 A1
(43) Pub. Date: Aug. 13, 2015

(54) Hand-Held Motor-Driven Cutting Device

(71) Applicant: Christoph Schiedt, Burgrieden (DE)

(72) Inventor: Christoph Schiedt, Burgrieden (DE)

(73) Assignee: HUSQVARNA AB, Huskvarna (SE)

(21) Appl. No.: 14/377,764

(22) PCT Filed: Feb. 17, 2012
(86) PCT No.: PCT/SE12/50177

§ 371 Date: Aug. 8, 2014

(51) Int. Cl. A01G 3/053; B23Q 5/027; B23Q 5/58; B25F 5/00

(52) U.S. Cl. CPC A01G 3/053; B25F 5/00; B23Q 5/027; B23Q 5/58; A01G 2003/0461

(57) ABSTRACT

A hand-held motor-driven cutting device is provided, comprising a motor 2, a first cutting tool 3, and a first transmission arranged to translate a rotating motion to a reciprocating motion of the first cutting tool 3. The first transmission comprises a first rotatable part 6 arranged to be driven by the motor 2 and a first connecting rod 9 with a first end 11 and a second end 12. The first end 11 is eccentrically connected to the first rotatable part 6 at a first connecting point 10 of the first rotatable part 6 and the second end 12 is connected to the first cutting tool 3. The first transmission 5 comprises a force limiting element 4 arranged between the first rotatable part 6 and the first cutting tool 3 in order to prevent a transmitted force applied to the first cutting tool 3 from exceeding a predetermined force level. The present invention also relates to a method of transmitting momentum in a hand-held motor-driven cutting device.

### TECHNICAL FIELD

The present invention relates to a hand-held motor-driven cutting device, such as a hedge trimmer. The present invention further relates to a method of transmitting momentum in a hand-held motor-driven cutting device.

### BACKGROUND

With a cutting device such as a hedge trimmer, an operator may cut vegetation, such as bushes, branches, grass etc. A hedge trimmer may comprise two cutting tools, e.g. cutting blades, reciprocating with respect to each other, wherein a relative motion between the two cutting tools may perform a cutting motion. Also, a hedge trimmer may comprise one reciprocating cutting tool, e.g. cutting blade, cooperating with a stationary cutting tool to perform cutting. The blades are driven by means of a motor, e.g. an electrical motor or a combustion engine. A transmission is arranged to translate the rotating motion from the motor to a reciprocating motion of the blades. During cutting, the blades of the cutting device may be blocked by thick branches. To unblock the blades may be cumbersome and time consuming. Also, there is a risk of damaging the cutting blades or the transmission of the cutting apparatus when the blades are blocked, especially if the blades are blocked by a hard material such as a steel wire of e.g. a fence.

Attempts have been made to protect the blades or the transmission of a hedge trimmer by using a clutch mechanism arranged between the motor and the transmission, for example in the Bosch hedge trimmer AHS 7000 or in a hedge trimmer as described in the document EP 1332665 A1. In these systems, kinetic energy of the motor is transmitted via the clutch to the transmission. In case the blades are blocked, the kinetic energy of the motor is intended to dissipate over the clutch, as the motor slows down and stops. In such a system a relatively high force is transmitted from the motor to the blades in case the blades are blocked, due to the high inertia of the motor, clutch mechanism and parts of the transmission. Further, the force transmitted to the blades is dependent of the rotational speed of the motor and manufacturing tolerances of the clutch mechanism. This may lead to a system in which an unpredictable force level is transferred to the blades in case the blades are blocked. Further, the operator often manually has to remove the obstacle blocking the blades, before the engine can be restarted. Moreover, the solution with a clutch mechanism is expensive, bulky and will add considerable weight to the cutting device.

### SUMMARY

An object of the present invention is to protect a cutting tool or a transmission of a cutting device from being damaged in case the cutting tool is blocked.

According to an aspect of the invention, the object is achieved by a hand-held motor-driven cutting device comprising a motor, a first cutting tool, and a first transmission arranged to translate a rotating motion to a reciprocating motion of the first cutting tool. The first transmission comprises a first rotatable part arranged to be driven by the motor and a first connecting rod with a first end and a second end. The first end is eccentrically connected to the first rotatable part at a first connecting point of the first rotatable part and the second end is connected to the first cutting tool. The first transmission comprises a force limiting element arranged between the first rotatable part and the first cutting tool in order to prevent a transmitted force applied to the first cutting tool from exceeding a predetermined force level.

Since the force limiting element is arranged between the first rotatable part and the first cutting tool, a force applied to the first cutting tool is prevented from exceeding the predetermined force level. As a result, the above mentioned object is achieved.

According to some embodiments, the hand-held motor-driven cutting device may be a hand-held hedge trimmer. According to further embodiments the cutting device may be a motor-driven pair of scissors, or a motor-driven secateurs or any other form of hand-held motor-driven cutting device.

The first cutting tool may comprise one or more cutting edges. The first cutting tool may comprise a cutting blade e.g. a cutting blade for a motor-driven hedge trimmer, a motor-driven pair of scissors, or a motor-driven secateurs. The first cutting tool may comprise one or more cutting blades arranged on an arm or may comprise one or more cutting teeth arranged on an arm. The first transmission may translate a rotating motion from the motor to a reciprocating motion of the first cutting tool. The motor may be an electrical motor or a combustion engine. The expression “the first cutting tool is blocked” above is intended to encompass a partial reduction of the reciprocating motion of the first cutting tool caused by an obstacle hindering the motion of the first cutting tool, as well as a complete immobilisation of the first cutting tool. The motor may be directly connected to the first transmission or may be indirectly connected to the first transmission.

According to some embodiments, the first connecting rod may be arranged to be movable along a first direction. The first rotatable part may comprise a first crank pin adapted to slide in an elongated opening of the first connecting rod, so as to translate a rotating motion of the first rotatable part to a reciprocating motion of the first cutting tool. In such embodiments, the first cutting tool may be arranged to be movable in essentially the same direction as a direction of the reciprocating motion of the first connecting rod. Consequently, in such embodiments, the cutting device may utilize a simple and robust mechanism for translating the rotating motion of the first rotatable part to a reciprocating motion of the first cutting tool.

According to some embodiments, the force limiting element may at least reduce the reciprocating motion of the first cutting tool when the transmitted force applied to the first cutting tool reaches the predetermined force level. In this manner, the cutting tool and/or the transmission may be protected from being damaged in case the cutting tool is blocked. Furthermore, an operator of the cutting device may easily remove the first cutting tool from an object blocking the first cutting tool, since the reciprocating motion of the first cutting tool may continue although at reduced length.

According to some embodiments, the force limiting element permits the motor and the first rotatable part to continue to rotate in case the first cutting tool is blocked. In this manner, at least the engine and the first rotatable part in the transmission may continue to rotate, whereby the rotating momentum of at least the engine and the first rotatable part may be conserved. Further, the transmission may apply a force, up to the predetermined force level, to the first cutting tool in a pulsating manner in case the first cutting tool is blocked by a blocking object. Accordingly, the first cutting tool may apply a force in a pulsating manner to the blocking object to thereby increase the possibility of cutting through the blocking object. The applied force to the blocking object may vary between the predetermined force level and substantially zero. In case several successive cutting motions fail to cut through the blocking object, an operator may remove the first cutting tool from the blocking object due to the applied force in a pulsating manner.

According to some embodiments, the force limiting element may comprise a resilient element. The resilient element may comprise a spring or a rubber material. Further, according to some embodiments, the resilient element may comprise a pre-tensioned spring element. Further, the force limiting element may comprise a pre-tensioned and/or pre-compressed rubber material.

According to some embodiments, the force limiting element may permit the first connecting point to move in a radial direction of the first rotatable part such that a stroke of the first connecting rod is adapted to be dynamically altered to prevent the transmitted force applied to the first cutting tool from exceeding a predetermined force level. Since the first end of the first connecting rod is eccentrically connected to the first rotatable part at a first connection point and the second end is connected to the first cutting tool, and the first rotatable part is arranged to be driven by the engine, the transmitted force supplied to the first cutting tool may be prevented from exceeding the predetermined force level by permitting the first connecting point to move in a radial direction of the first rotatable part. In case the first cutting tool is blocked by a blocking object such as for example by a thick branch or a steel wire of e.g. a fence, the first connecting point may move in a radial direction such that a stroke of the first connecting rod is reduced. The transmitted force to the first cutting tool may thereby be prevented from exceeding a predetermined force level. When the first cutting tool is removed from the blocking object, a centrifugal force exerted inter alia on the first end of the first connecting rod and caused by the rotation of the first rotatable part, may ensure that the stroke of the first connecting rod is increased.

According to some embodiments, the hand-held motor-driven cutting device may comprise a second cutting tool cooperating with the first cutting tool. In such embodiments, the first cutting tool and the second cutting tool may reciprocate with respect to each other, wherein a relative motion between the two cutting tools may perform a cutting motion. Alternatively, the second cutting tool may be fixed in relation to the cutting device.

According to some embodiments, the hand-held motor-driven cutting device may comprise a second transmission arranged to translate a rotating motion to a reciprocating motion of the second cutting tool. In such embodiments, the second transmission may comprise essentially corresponding parts as the first transmission or may share at least one part with the first transmission.

According to some embodiments, the second transmission may comprise a second connecting rod with a first end and a second end. The first end may be eccentrically connected to the first rotatable part at a second connecting point of the first rotatable part and the second end may be connected to the second cutting tool. The second transmission may comprise a further force limiting element arranged between the first rotatable part and the second cutting tool in order to prevent a transmitted force applied to the second cutting tool from exceeding a predetermined force level. In such embodiments, the first connecting rod and the second connecting rod may be eccentrically connected to one rotatable part. The first end of the first connecting rod may be eccentrically connected to the first part at a first connecting point different from the second connecting point.

According to some embodiments, the second transmission may comprise a second rotatable part, arranged to be driven by the motor and a second connecting rod with a first end and a second end. The first end may be eccentrically connected to the second rotatable part at a second connecting point of the second rotatable part and the second end may be connected to the second cutting tool. The second transmission may comprise a further force limiting element arranged between the second rotatable part and the second cutting tool in order to prevent a transmitted force applied to the second cutting tool from exceeding a predetermined force level. In such embodiments, the two rotatable parts may rotate at essentially the same rotational speed, and may be driven by the same motor. The first rotatable part and the second rotatable part may have a mechanical connection or any other inter-locking structure such that the first and the second rotatable part may rotate at essentially the same rotational speed. In such embodiments, the first end of the first connecting rod may be eccentrically connected to the first rotatable part at an angle different from an angle in which the first end of the second connecting rod is eccentrically connected to the second rotatable part. The angle between the first connecting point of the first rotatable part and the second connecting point of the second rotatable part may be approximately 180 degrees.

According to an aspect of the invention, the object is achieved by, a method of transmitting momentum in a hand-held motor-driven cutting device comprising;
supplying a rotary motion from a motor to a first rotatable part,
translating the rotary motion of the first rotatable part to a reciprocating motion of a first cutting tool utilizing a first transmission comprising a first connecting rod with a first end and a second end, wherein the first end is eccentrically connected to the first rotatable part at a first connection point of the first rotatable part and the second end is connected to the first cutting tool, and
preventing a transmitted force applied to the first cutting tool from exceeding a predetermined force level by means of a force limiting element arranged between the first rotatable part and the first cutting tool.

Again, since a force limiting element is arranged between the first rotatable part and the first cutting tool, a force applied to the first cutting tool is prevented from exceeding the predetermined force level. As a result, the above mentioned object is achieved.

Further features of, and advantages with, the present invention will become apparent when studying the appended claims and the following detailed description. Those skilled in the art will realize that different features of the present invention may be combined to create embodiments other than those described in the following, without departing from the scope of the present invention, as defined by the appended claims.

### BRIEF DESCRIPTION OF THE DRAWINGS

The various aspects of the invention, including its particular features and advantages, will be readily understood from the following detailed description and the accompanying drawings, in which:

FIG. 1 illustrates a cutting device according to some embodiments.

FIG. 2 illustrates a schematic view of a first transmission of a cutting device comprising a force limiting element according to some embodiments.

FIG. 3 illustrates a schematic view of a first transmission and a second transmission of a cutting device comprising a force limiting element and a further force limiting element according to some embodiments.

FIGS. 4 and 5 illustrate a schematic view of a first transmission of a cutting device comprising a force limiting element according to some embodiments.

FIG. 6 illustrates a schematic view of a force limiting element according to some embodiments.

FIG. 7 illustrates a method of transmitting momentum in a hand-held motor-driven cutting device according to some embodiments.

### DETAILED DESCRIPTION

The present invention will now be described more fully with reference to the accompanying drawings, in which example embodiments are shown. However, this invention should not be construed as limited to the embodiments set forth herein. Disclosed features of example embodiments may be combined as readily understood by one of ordinary skill in the art to which this invention belongs. Like numbers refer to like elements throughout.

Well-known functions or constructions will not necessarily be described in detail for brevity and/or clarity.

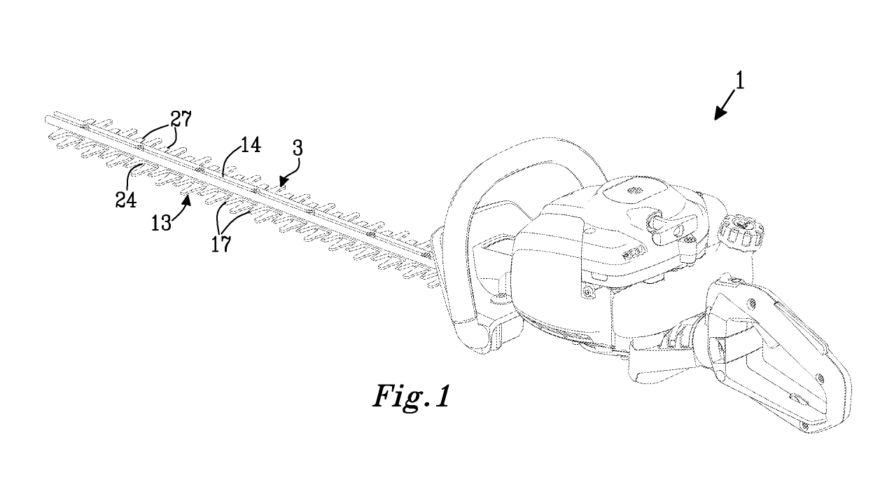

FIG. 1 illustrates a hand-held cutting device 1 according to some embodiments. The cutting device 1 is a motor-driven hand-held hedge trimmer. The cutting device 1 comprises a first cutting tool 3 comprising an arm 14 provided with cutting teeth 17. The cutting device 1 further comprises a motor 2, in the form of a combustion engine. Alternatively, the cutting device 1 may comprise an electric motor. As explained below, the first cutting tool 3 may be driven, in a reciprocating motion, by the motor 2. The cutting device 1 may comprise a second cutting tool 13, comprising an arm 24 and cutting teeth 27. The second cutting tool 13 may also be driven by the motor 2 in a reciprocating motion whereby a relative motion of the first and the second cutting tools 3, 13 performs a cutting motion. Alternatively, the second cutting tool 13 may be fixed in relation to the cutting device 1.

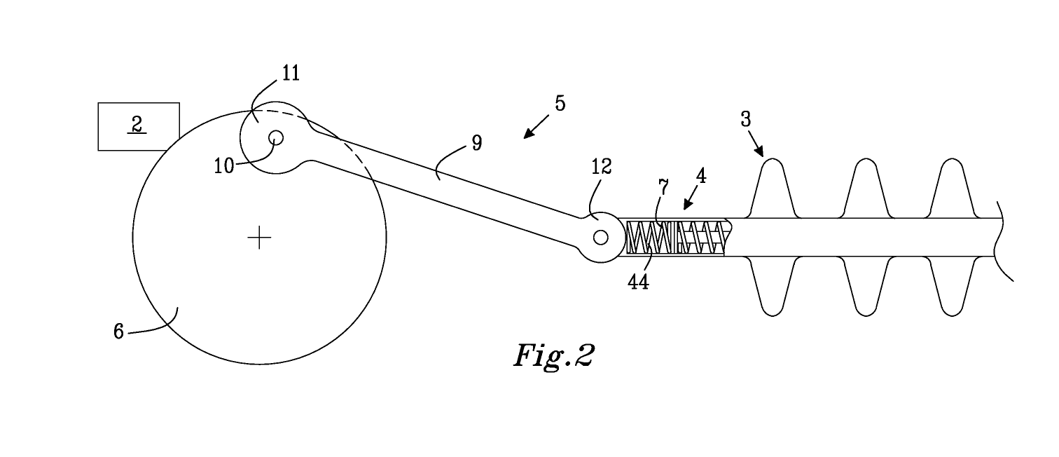

FIG. 2 illustrates a schematic view of a first transmission 5 of a cutting device comprising a force limiting element 4 according to some embodiments. The first transmission 5 comprises a first connecting rod 9 with a first end 11 and a second end 12. The first end 11 is eccentrically connected to the first rotatable part 6 at a first connecting point 10 of the first rotatable part 6. The second end 12 of the first connecting rod 9 is connected to the first cutting tool 3. The first rotatable part 6 is arranged to be driven by the motor 2. Due to the rotation of the first rotatable part 6, and the eccentric first connecting point 10 of the first end 11 of the first connecting rod 9 at the first rotatable part 6, the rotating motion of the first rotatable part 6 is translated to a reciprocating motion of the first cutting tool 3.

The first rotatable part 6 may be directly connected to the motor 2 or may be indirectly connected to the motor 2. Such indirect connection (not shown in the figures) may comprise a bevel gear and/or a speed reduction gear and/or a belt- or a cord-drive mechanism and/or a clutch mechanism or any other form of mechanism that may transmit a rotating motion from the motor 2 to a rotating motion of the first rotatable part 6. Accordingly, the indirect connection between the motor 2 and the first rotatable part 6 may comprise a speed reduction gear and may translate a direction and/or angle of rotation from the motor 2 to a different direction and/or angle of rotation of the first rotatable part 6. The first rotatable part 6 may comprise a toothed wheel for direct or indirect engagement with the motor 2.

The transmission 5 comprises a force limiting element 4. The force limiting element 4 prevents a transmitted force applied to the first cutting tool 3 from exceeding a predetermined force level, e.g. in case the first cutting tool 3 is blocked. The force limiting element 4 illustrated in FIG. 2 is arranged between the second end 12 of the first connecting rod 9 and the first cutting tool 3. Alternatively, the force limiting element 4 may be arranged at a different position between the first rotatable part 6 and the first cutting tool 3. Several different positions of the force limiting element are envisaged, for example:
the force limiting element 4 may be arranged between the first end 11 and the second end 12 of the first connecting rod 9 and may form an integral part of the first connecting rod 9.
the force limiting element 4 may be arranged at the first end 11 of the first connecting rod 9.
the force limiting element 4 may be arranged at the second end 12 of the first connecting rod 9.
the force limiting element 4 may be arranged at the first connecting point 10.

According to some embodiments, the force limiting element 4 may comprise a resilient element 7 or may comprise a plurality of resilient elements. The resilient element 7 or elements may comprise a spring element and/or a rubber material and/or a rubber-like material. The resilient element 7 illustrated in FIG. 2 comprises a pre-tensioned spring element 44. Alternatively, the force limiting element 4 may comprise a plurality of pre-tensioned spring elements.

The force limiting element 4 is adapted to transmit a force to the first cutting tool 3 sufficient for the first cutting tool 3 to perform cutting. That is, in embodiments wherein the cutting device 1 is a hedge trimmer, the force limiting element 4 may be adapted to transmit a force to the first cutting tool 3 sufficient to cut branches with a certain cutting resistance, e.g. branches with a diameter that fits between a tooth of the first cutting tool 3 and a tooth of a second cutting tool (not shown in FIG. 2). In embodiments wherein the cutting device is a motor-driven pair of scissors or a motor-driven secateurs, the force limiting element may be adapted to transmit a force to the first cutting tool sufficient to cut normally occurring cutting matter with a certain cutting resistance, e.g. a density and a diameter of the cutting matter.

Further, the force limiting element is adapted to prevent a transmitted force applied to the first cutting tool from exceeding a predetermined force level. That is, the applied force to the first cutting tool is prevented from exceeding a force that may cause damage to the first cutting tool or other parts of the cutting device. Moreover, the force limiting element at least may reduce the reciprocating motion of the first cutting tool when the transmitted force applied to the first cutting tool reaches the predetermined force level. In embodiments wherein the cutting device 1 is a hedge trimmer, as in FIG. 1, the force limiting element 4 may be adapted to reduce the reciprocating motion of the first cutting tool 3 only partially or substantially fully, i.e. in the latter case to an extent such that a blocking object may fit between two cutting teeth.

The force limiting element 4 may permit the motor 2 and the first rotatable part 6 to continue to rotate in case the first cutting tool 3 is blocked. Thus, the transmission may apply a force, up to the predetermined force level, to the first cutting tool 3 in a pulsating manner in case the first cutting tool 3 is blocked by a blocking object. The applied force may vary between the predetermined force and substantially zero. Accordingly, the first cutting tool 3 may apply a force in a pulsating manner to the blocking object. Due to the fact that the cutting tool 3 applies a force in a pulsating manner to the blocking object, an operator may easily remove the first cutting tool 3 from the blocking object. Also, the applied force in a pulsating manner by the first cutting tool 3 to the blocking object may increase the possibility of cutting through the blocking object.

In embodiments wherein the force limiting element 4 comprises a resilient element 7, the resilient element 7 may intermittently being compressed and expanded in case the first cutting tool 3 is blocked. In such embodiments, when the resilient element 7 is compressed, kinetic energy may be stored in the form of compression force in the resilient element 7. When the resilient element 7 is expanded, due to the continuous rotation of the first rotatable part 6, the compression force in the resilient element 7 may be released and may therefore contribute to the rotation of the first rotatable part 6 and may thus also contribute to the rotation of the motor 2. Therefore, in such embodiments, a rotational speed of the motor 2 may increase when the first cutting tool 3 is blocked.

As described above in connection with FIG. 2, the cutting device may only comprise one transmission, i.e. the first transmission 5. However, the cutting device may comprise a second transmission. The second transmission may be arranged to translate a rotating motion to a reciprocating motion of a second cutting tool. The second cutting tool may cooperate with the first cutting tool 3 to perform cutting. In such embodiments, the second transmission may comprise essentially corresponding parts as the first transmission or may share at least one part with the first transmission 5.

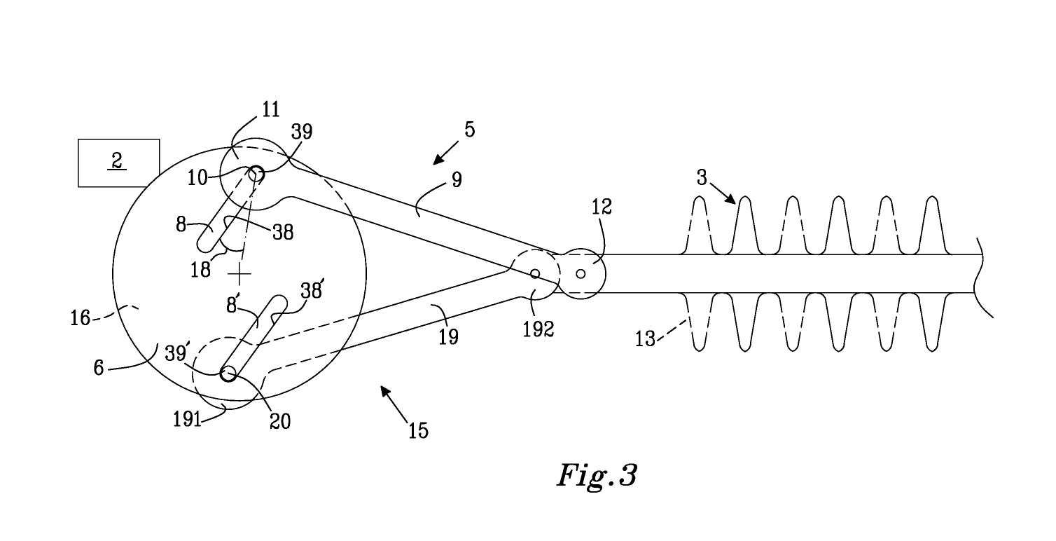

FIG. 3 illustrates a schematic view of a first transmission 5 and a second transmission 15 of a cutting device comprising a force limiting element 8 and a further force limiting element 8′ according to some embodiments. The first transmission 5 comprises a first connecting rod 9 with a first end 11 and a second end 12. The first end 11 is eccentrically connected to a first rotatable part 6 at a first connecting point 10 of the first rotatable part 6. The second end 12 of the first connecting rod 9 is connected to a first cutting tool 3. The first rotatable part 6 is arranged to be driven by a motor 2. Due to the rotation of the first rotatable part 6, and the eccentric first connecting point 10 of the first end 11 of the first connecting rod 9 at the first rotatable part 6, the rotating motion of the first rotatable part 6 is translated to a reciprocating motion of the first cutting tool 3. The transmission 5 comprises a force limiting element 8. The force limiting element 8 prevents a transmitted force applied to the first cutting tool 3 from exceeding a predetermined force level, e.g. in case the first cutting tool 3 is blocked.

The force limiting element 8 permits the first connecting point 10 to move in a radial direction of the first rotatable part 6. Thus, a stroke of the first connecting rod 9 is adapted to be dynamically altered to thereby prevent the transmitted force applied to the first cutting tool 3 from exceeding the predetermined force level. In case the first cutting tool 3 is blocked, the force limiting element 8 permits the first connecting point 10 to move in a radial direction of the first rotatable part 6 such that a stroke of the first connecting rod 9 is reduced. The transmitted force to the first cutting tool 3 is thereby prevented from exceeding the predetermined force level. Due to the reduction of the stroke of the first connecting rod 9 the reciprocating motion of the first cutting tool 3 is reduced.

The force limiting element 8 may permit the motor 2 and the first rotatable part 6 to continue to rotate in case the first cutting tool 3 is blocked. In such embodiments, the force limiting element 8 permits the first connecting point 10 to move in a radial direction of the first rotatable part 6 such that the reduction of the stroke of the first connecting rod 9 permits a continuous rotation of the first rotatable part 6. Due to the force limiting element 8 permitting the motor 2 and first rotatable part 6 to continue to rotate and the first connecting point 10 to rotate at a smaller radius on the first rotatable part 6, the kinetic energy of at least the first rotatable part 6 and the motor 2 may be maintained.

When the first cutting tool 3 is unblocked, a centrifugal force exerted inter alia on the first end 11 of the first connecting rod 9 and caused by the rotation of the first rotatable part 6, ensures that the stroke of the first connecting rod 9 and the reciprocating motion of the first cutting tool 3 is increased. Further, the centrifugal force exerted inter alia on the first end 11 of the first connecting rod 9 and caused by the rotation of the first rotatable part 6, ensures that the force limiting element 8 permits the transmitted force applied to the first cutting tool 3 to reach the predetermined force level or a force level sufficient for the first cutting tool 3 to perform cutting. A transmitted force applied to the first cutting tool 3 may be determined by a mass of rotating parts (e.g. the first connecting rod 9), the radius of the connecting point 10 to the rotatable part 6 and an angular velocity of the rotatable part 6.

The force limiting element 8 comprises a portion of the first rotatable part 6 provided with a slot 38 and a pin 39 comprising the first connecting point 10 slidably arranged in the slot 38. The pin 39 is connected to the first end 11 of the first connecting rod 9. As an alternative to a slot and a pin there may be provided a recess or a spline or any other structure that permits the first connecting point 10 to move in a radial direction of the first rotatable part 6.

As illustrated in FIG. 3, the slot 38 of the force limiting element 8 may be arranged at an angle 18 to the radial direction of the first rotatable part 6. The angle 18 of the slot 38 of the force limiting element 8 may further prevent the transmitted force applied to the first cutting tool 3 from exceeding the predetermined force level. Also, the angle 18 of the slot 38 of the force limiting element 8 may further permit the transmitted force applied to the first cutting tool 3 to reach the predetermined force level or a force level sufficient for the first cutting tool 3 to perform cutting. In general, a large angle 18 of the slot 38 of the force limiting element 8 results in a low force applied to the first cutting tool 3 and a small angle 18 of the slot 38 of the force limiting element 8 results in a high force applied to the first cutting tool 3. As illustrated in FIG. 3, the slot 38 permits the first connecting point 10 to move in a straight line along the first rotatable part 6. Alternatively, the slot may be curved to permit the first connecting point 10 to move in a curved line along the first rotatable part 6. In a further alternative, the slot may be arranged in a direction straight towards a centre of the first rotatable part 6 to permit the first connecting point 10 to move in a direction straight towards a centre of the first rotatable part 6.

As described above in connection with FIG. 3, the cutting device may only comprise one transmission, i.e. the first transmission 5. However, the cutting device may comprise a second transmission 15. In such embodiments, the second transmission 15 comprises a second connecting rod 19 with a first end 191 and a second end 192. The first end 191 is eccentrically connected to the first rotatable part 6 at a second connecting point 20 of the first rotatable part 6 and the second end 192 is connected to a second cutting tool 13. A further force limiting element 8′ is arranged between the first rotatable part 6 and the second cutting tool 13 in order to prevent a transmitted force applied to the second cutting tool 13 from exceeding a predetermined force level. The further force limiting element 8′ comprises a portion of the first rotatable part 6 provided with a second slot 38′ and a second pin 39′ slidably arranged in the second slot 38′ and being connected to a first end 191 of the second connecting rod 19. Again, as an alternative to a slot and a pin there may be provided a recess or a spline or any other structure that permits the second connecting point 20 to move in a radial direction of the first rotatable part 6. In case the first or the second cutting tools 3, 13 are blocked by a blocking object, the blocking object may be caught between the first and the second cutting tools 3, 13.

According to alternative embodiments, the second transmission 15 may comprise a second rotatable part 16, arranged to be driven by the motor 2. The second rotatable part 16 is indicated in FIG. 3 and is concentric with the first rotatable part 6. In these embodiments, the first end 191 of the second connecting rod 19 is eccentrically connected to the second rotatable part 16 at a second connecting point 20 of the second rotatable part 16 and the second end 192 is connected to the second cutting tool 13. A further force limiting element 8′ is arranged between the second rotatable part 16 and the second cutting tool 13 in order to prevent a transmitted force applied to the second cutting tool 13 from exceeding a predetermined force level. Thus, a slot 38′ of the further force limiting element 8′ as indicated in the first rotatable part 6 is in these embodiments provided in the second rotatable part 16 concentric with the first rotatable part 6 in FIG. 3.

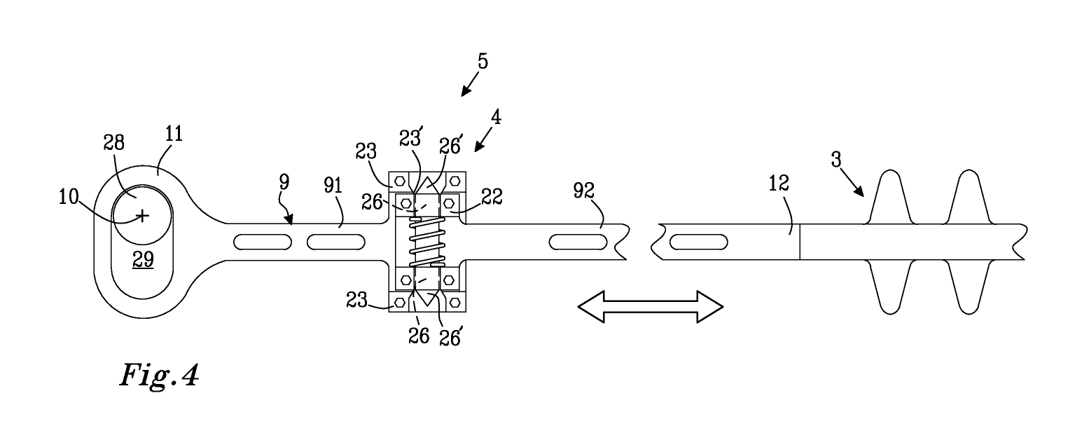

FIG. 4 illustrates a schematic view of a first transmission 5 of a cutting device comprising a force limiting element 4 according to some embodiments. The first transmission 5 comprises a first connecting rod 9 with a first end 11 and a second end 12. The first end 11 is eccentrically connected to a first rotatable part (not shown in FIG. 4) of the first transmission 5 via a first crank pin 28 at a first connecting point 10 of the first rotatable part. The second end 12 is connected to the first cutting tool 3. The first crank pin 28 is adapted to slide in an elongated opening 29 arranged in a region of the first end 11 of the first connecting rod 9. The first rotatable part is arranged to be driven by a motor (not shown in FIG. 4). Due to the rotation of the first rotatable part, and the eccentric first connecting point 10 of the first end 11 of the first connecting rod 9 at the first rotatable part, the rotating motion of the first rotatable part is translated to a reciprocating motion of the first connecting rod 9. During rotation of the first rotatable part, the first crank pin 28 slides in the elongated opening 29 and the first connecting rod 9 is arranged to reciprocate substantially along one direction. The first cutting tool 3 may be arranged to reciprocate along the same direction as the first connecting rod 9. The transmission 5 comprises a force limiting element 4. The force limiting element 4 prevents a transmitted force applied to the first cutting tool 3 from exceeding a predetermined force level, e.g. in case the first cutting tool 3 is blocked.

The force limiting element 4 is arranged between the first end 11 and the second end 12 of the first connecting rod 9 and forms a part of the first connecting rod 9. Alternatively, the force limiting element 4 may not form a part of the first connecting rod 9 and may be arranged at a different position between the first rotatable part and the first cutting tool 3. Several different positions of the force limiting element 4 are envisaged, for example:
the force limiting element 4 may be arranged at the first end 11 of the first connecting rod 9.
the force limiting element 4 may be arranged at the second end 12 of the first connecting rod 9.

As illustrated in FIG. 4, the force limiting element 4 comprises a seat 23 connected to a first part 91 of the first connecting rod 9 and a sleeve 22 connected to a second part 92 of the first connecting rod 9. The force limiting element 4 further comprises at least one pin 26 slidably arranged in the sleeve 22. The at least one pin 26 is provided with at least one tapered portion 26′ and is biased such that at least the at least one tapered portion 26′ of that least one pin 26 is forced against a recessed portion 23′ of the seat 23. Accordingly, in ordinary operation the force limiting element 4 holds the first and second parts 91, 92 of the first connecting rod 9 together.

When the first cutting tool 3 is blocked, an applied force to the first part 91 of the first connecting rod 9 initiates an interaction between the recessed portion 23′ of the seat 23 and the at least one tapered portion 26′ of the at least one pin 26 displaces the at least one pin 26 in a first direction in relation to the sleeve 22 such that a relative movement between the sleeve 22 and the seat 23 is allowed. As a result, the force limiting element 4 prevents a transmitted force applied to the first cutting tool 3 from exceeding a predetermined force level. Moreover, the force limiting element 4 at least reduces the reciprocating motion of the first cutting tool 3 when the transmitted force applied to the first cutting tool 3 reaches the predetermined force level. In such embodiments, the relative movement between the sleeve 22 and the seat 23 at least reduces the reciprocating motion of the first cutting tool 3 when the transmitted force applied to the first cutting tool 3 reaches the predetermined force level.

When the first cutting tool 3 is unblocked, an interaction between the recessed portion 23′ of the seat 23 and the at least one tapered portion 26′ of the at least one pin 26 permits the at least one pin 26 to be displaced, e.g. by at least one spring element 31, in a second direction in relation to the sleeve 22 such that the interaction between the recessed portion 23′ of the seat 23 and the at least one tapered portion 26′ of the at least one pin 26 holds the sleeve 22 in relation to the seat 23. As a result, the force limiting element 4 permits the transmitted force applied to the first cutting tool 3 to reach the predetermined force level or a force level sufficient for the first cutting tool 3 to perform cutting.

The force limiting element 4 may be adapted to have an engaged state and a disengaged state. In the disengaged state, e.g. caused by a blocking of the first cutting tool 3, the at least one pin 26 is displaced by an interaction between the recessed portion 23′ of the seat 23 and the at least one tapered portion 26′ of the at least one pin 26 to a position, in which the at least one pin 26 substantially disengages from the sleeve 22. When the at least one pin 26 is disengaged from the sleeve 22, the sleeve 22 may slide in relation to the seat 23 without the pin 26 hindering the sliding. In such embodiments, when the force limiting element 4 assumes the disengaged state, the transmitted force applied to the first cutting tool 3 may be low, or even zero. In such embodiments, when the first cutting tool 3 is unblocked, a reciprocating motion of the seat 23 caused by a reciprocating motion of the first part 91 of the first connecting rod 9 ensures that the force limiting element 4 assumes the engaged state.

According to further embodiments, the cutting device may comprise a second transmission (not shown in FIG. 4) connected to a second cutting tool. In such embodiments, the second transmission comprises similar parts as the first transmission 5 illustrated in FIG. 4, in particular a second connecting rod with an elongated opening arranged in a region of a first end of the second connecting rod and a further force limiting element. In these embodiments, a second crank pin may be eccentrically connected to the first rotatable part at a first connecting point 10 of the first rotatable part. As an alternative, the second crank pin may be eccentrically connected to a second rotatable part.

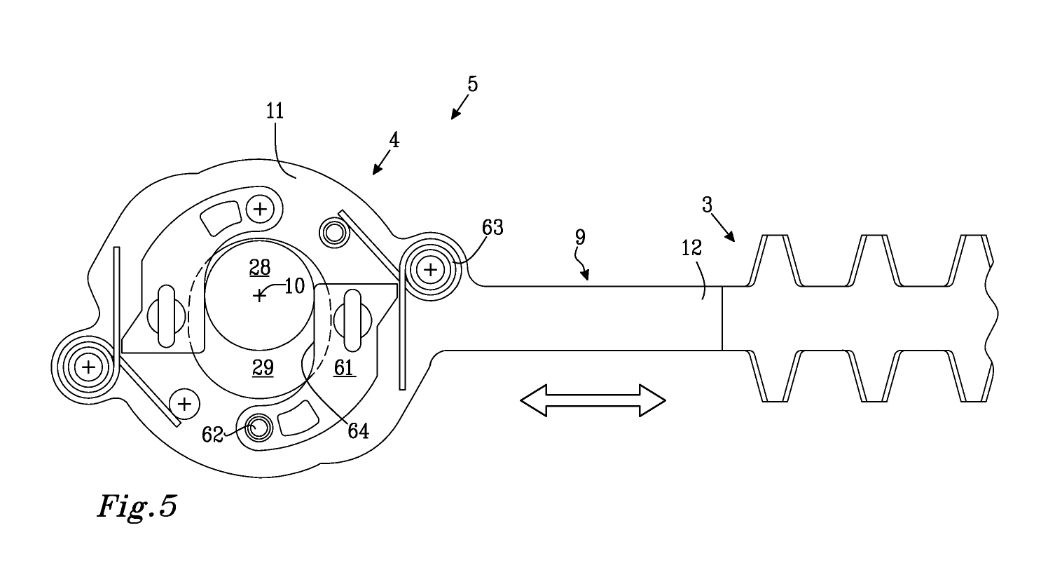

FIG. 5 illustrates a schematic view of a first transmission 5 of a cutting device comprising a force limiting element 4 according to some embodiments. The first transmission 5 comprises a first connecting rod 9 with a first end 11 and a second end 12. The first end 11 is eccentrically connected to a first rotatable part (not shown in FIG. 4) of the first transmission 5 via a first crank pin 28 at a first connecting point 10 of the first rotatable part. The second end 12 is connected to the first cutting tool 3. The first crank pin 28 is adapted to slide in an elongated opening 29 arranged in a region of the first end 11 of the first connecting rod 9. The first rotatable part is arranged to be driven by a motor (not shown in FIG. 5). Due to the rotation of the first rotatable part, and the eccentric first connecting point 10 of the first end at the first rotatable part, the rotating motion of the first rotatable part is translated to a reciprocating motion of the first connecting rod 9. During rotation of the first rotatable part, the first crank pin 28 slides in the elongated opening 29 and the first connecting rod 9 is arranged to reciprocate substantially along one direction. The first cutting tool 3 may reciprocate along the same direction as the first connecting rod 9. The transmission 5 comprises a force limiting element 4. The force limiting element 4 prevents a transmitted force applied to the first cutting tool 3 from exceeding a predetermined force level, e.g. in case the first cutting tool 3 is blocked.

The force limiting element 4 is arranged in a region of the elongated opening 29 and comprises at least one moveably arranged element 61 forming at least an adjacent portion 64 to the elongated opening 29. The at least one moveably arranged element 61 is biased, e.g. by at least one resilient element 63, towards a centre of the elongated opening 29. The at least one movably arranged element 61 may be biased to abut against the first crank pin 28 or against a separate stop element (not shown in FIG. 5). During ordinary operation, the at least one moveably arranged element 61 is essentially stationary in relation to the first connecting rod 9. As a result, the rotating motion of the first rotatable part is translated to a reciprocating motion of the first connecting rod 9. Also, the at least one movably arranged element 61 is biased with such a force towards the elongated opening 29 that the force limiting element 4 permits the transmitted force applied to the first cutting tool 3 to reach the predetermined force level or a force level sufficient for the first cutting tool 3 to perform cutting.

When the first cutting tool 3 is blocked, an interaction between the first crank pin 28 and the at least one moveably arranged element 61 displaces the at least one moveably arranged element 61. As a result, the force limiting element 4 prevents a transmitted force applied to the first cutting tool 3 from exceeding a predetermined force level. Moreover, the force limiting element 4 at least reduces the reciprocating motion of the first cutting tool 3 when the transmitted force applied to the first cutting tool 3 reaches the predetermined force level.

The force limiting element 4 may permit the motor and the first rotatable part 6 to continue to rotate in case the first cutting tool 3 is blocked. In such embodiments, the force limiting element 4 may permit the elongated opening to be widened and/or displaced in relation to the first connecting rod 9 to an extent permitting a continuous rotation of the first rotatable part. Due to the force limiting element 4 permitting the motor and first rotatable part to continue to rotate, kinetic energy of at least the first rotatable part and the motor may be maintained.

As illustrated in FIG. 5, the at least one moveably arranged element 61 may comprise a lever 61 connected to the first end of the first connecting rod at a pivot point 62. The at least one resilient element 63 may comprise a spring element or a plurality of spring elements. The force limiting element 4 may comprise a plurality of moveably arranged elements 61.

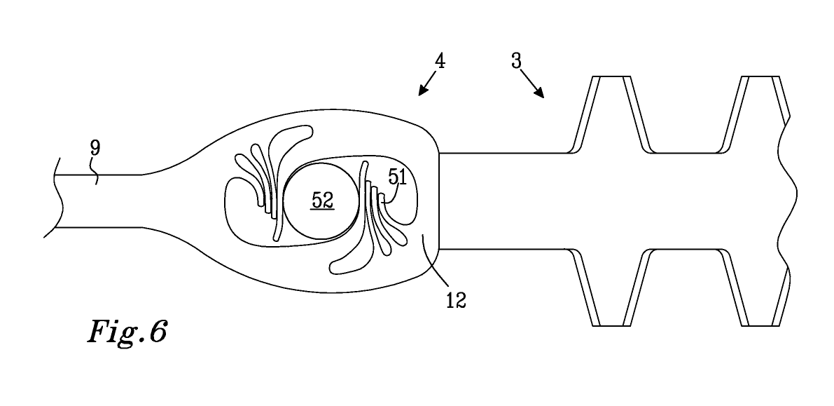

FIG. 6 illustrates a schematic view of a force limiting element 4 according to some embodiments. The force limiting element 4 is arranged between a second end 12 of a first connecting rod 9 of a first transmission of a cutting device and a first cutting tool 3 in order to prevent a transmitted force applied to the first cutting tool 3 from exceeding a predetermined force level, e.g. in case the first cutting tool 3 is blocked. The force limiting element 4 comprises at least one resilient element 51 and at least one connecting portion 52. The at least one connecting portion 52 is stationary arranged at the cutting tool 3. The at least one resilient element 51 may comprise a rubber material and/or a rubber-like material and/or a metal material, such as steel. Due to a resilience of the at least one resilient element 51, an applied force to the first cutting tool 3 is prevented from exceeding the predetermined force level. The first transmission of the cutting device is arranged to translate a rotating motion to a reciprocating motion of the first cutting tool 3. The first transmission comprises the first rotatable part, arranged to be driven by a motor and the first connecting rod 9 with a first end and the second end 12. The first end is eccentrically connected to the first rotatable part at a first connecting point of the first rotatable part and the second end 12 is connected to the first cutting tool 3. The force limiting element 4 illustrated in FIG. 6 may be arranged at a different position between the first rotatable part and the first cutting tool 3. Several different positions of the force limiting element 4 are envisaged, for example:
the force limiting element 4 may be arranged at the first end of the first connecting rod 9.
the force limiting element 4 may be arranged at the first connecting point.

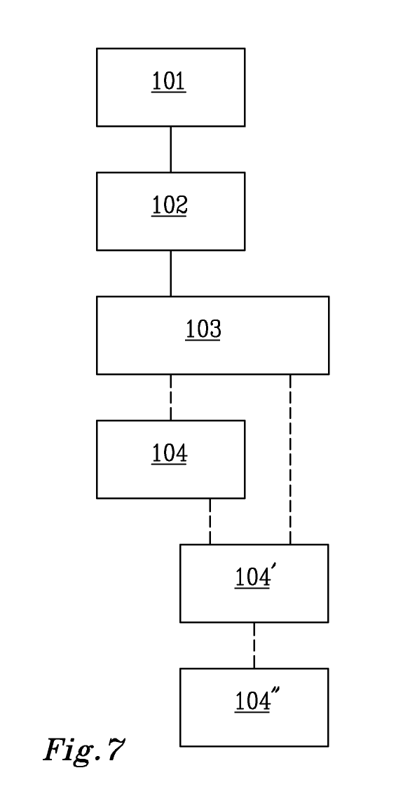

FIG. 7 illustrates a method of transmitting momentum in a hand-held motor-driven cutting device according to some embodiments. The method comprises;
supplying 101 a rotary motion from a motor to a first rotatable part,
translating 102 the rotary motion of the first rotatable part to a reciprocating motion of a first cutting tool utilizing a first transmission comprising a first connecting rod with a first end and a second end, wherein the first end is eccentrically connected to the first rotatable part at a first connection point of the first rotatable part and the second end is connected to the first cutting tool, and
preventing 103 a transmitted force applied to the first cutting tool from exceeding a predetermined force level utilizing a force limiting element arranged between the first rotatable part and the first cutting tool.

Since a force limiting element is arranged between the first rotatable part and the first cutting tool, the force applied to the first cutting tool is prevented from exceeding the predetermined force level.

The method of transmitting momentum in a hand-held motor-driven cutting device may further comprise;
limiting 104 the transmitted force to the first cutting tool utilizing the force limiting element arranged between the second end of the first connecting rod and the first cutting tool.

Since the force limiting element may be arranged between the second end of the first connecting rod and the first cutting tool, the force applied to the first cutting tool may be prevented from exceeding the predetermined force level.

The method of transmitting momentum in a hand-held motor-driven cutting device may further comprise;
limiting 104′ the transmitted force to the first cutting tool utilizing the force limiting element arranged between the first rotatable part and the first end of the first connecting rod.

Since the force limiting element may be arranged between the first rotatable part and the first end of the first connecting rod, the force applied to the first cutting tool may be prevented from exceeding the predetermined force level.

The method of transmitting momentum in a hand-held motor-driven cutting may further comprise;
limiting 104″ the transmitted force to the first cutting tool by permitting the first eccentric connection point to move in a radial direction of the first rotatable part.

In such embodiments, the transmitted force to the first cutting tool may be limited by permitting the first eccentric connection point to move in a radial direction of the first rotatable part. As a result, the force applied to the first cutting tool may be prevented from exceeding the predetermined force level.

Example embodiments described above may be combined as understood by a person skilled in the art. It is also understood by those skilled in the art that embodiments related to various force liming elements may be combined. The cutting device may comprise a plurality of force limiting elements. In such embodiments, the force limiting elements may be arranged in more than one different position between a first cutting tool and a first rotatable part and in combinations thereof. For instance, a force limiting element arranged between a second end of a first connecting rod and a first cutting tool may be combined with a force limiting element arranged between a first end of the first connecting rod and a first rotatable part.

Although the invention has been described with reference to example embodiments, many different alterations, modifications and the like will become apparent for those skilled in the art. For instance, according to embodiments described in connection with FIG. 4 or FIG. 5, the force limiting element may be arranged at the first connecting point 10. In such embodiments, the force limiting element permits the first crank pin 28 at first connecting point 10 of the first rotatable part to move in a radial direction of the first rotatable part to thereby prevent a transmitted force applied to the first cutting tool 3 from exceeding a predetermined force level. In such embodiments, the principle and function of the force limiting element corresponds to the force limiting element described in connection with FIG. 3 with the exception that the centrifugal force exerted inter alia on the first end 11 of the first connecting rod 9 as described in connection with FIG. 3 is replaced with a centrifugal force exerted inter alia on the first crank pin 28.

According to embodiments wherein the force limiting element permits the first connecting point to move in a radial direction of the first rotatable part, the force limiting element may comprise a resilient element that applies a force to the first connecting point in the radial direction of the first rotatable part to thereby further ensure that the force limiting element permits a transmitted force applied to the first cutting tool to reach the predetermined force level or a force level sufficient for the first cutting tool to perform cutting. Alternatively, the force limiting element may comprise a resilient element that applies a force to the first connecting point in the radial direction of the first rotatable part, counteracting the centrifugal force exerted inter alia on the first end of the first connecting rod and caused by the rotation of the first rotatable part to thereby further prevent the transmitted force to the first cutting tool from exceeding the predetermined force level.

It is to be understood that the foregoing is illustrative of various example embodiments and the invention is not to be limited to the specific embodiments disclosed and that modifications to the disclosed embodiments, combinations of features of disclosed embodiments as well as other embodiments are intended to be included within the scope of the appended claims.

As used herein, the term “comprising” or “comprises” is open-ended, and includes one or more stated features, elements, steps, components or functions but does not preclude the presence or addition of one or more other features, elements, steps, components, functions or groups thereof.

As used herein, the term “and/or” includes any and all combinations of one or more of the associated listed items.

As used herein, the common abbreviation “e.g.”, which derives from the Latin phrase “exempli gratia,” may be used to introduce or specify a general example or examples of a previously mentioned item, and is not intended to be limiting of such item. If used herein, the common abbreviation “i.e.”, which derives from the Latin phrase “id est,” may be used to specify a particular item from a more general recitation.

The terminology used herein is for the purpose of describing particular embodiments only and is not intended to be limiting of the invention. As used herein, the singular forms “a”, “an” and “the” are intended to include the plural forms as well, unless the context clearly indicates otherwise.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

It will be understood that when an element is referred to as being “on” or “connected” to another element, it can be directly on or connected to the other element or intervening elements may also be present. In contrast, when an element is referred to as being “directly on” or “directly connected” to another element, there are no intervening elements present.

It will be understood that although the terms first, second, third etc. may be used herein to describe various elements and/or components, these elements and/or components should not be limited by these terms. These terms are only used to distinguish one element and/or component from another element and/or component. Thus, a first element and/or component discussed herein could be termed a second element and/or component without departing from the teachings of the present invention.

1. A hand-held motor-driven cutting device, comprising:
a motor,
a first cutting tool, and
a first transmission arranged to translate a rotating motion to a reciprocating motion of the first cutting tool, the first transmission comprising:
a first rotatable part, arranged to be driven by the motor, and a first connecting rod with a first end and a second end, wherein the first end is eccentrically connected to the first rotatable part at a first connecting point of the first rotatable part and the second end is connected to the first cutting tool,
wherein the first transmission comprises a force limiting element arranged between the first rotatable part and the first cutting tool in order to prevent a transmitted force applied to the first cutting tool from exceeding a predetermined force level.

2. The hand-held motor-driven cutting device according to claim 1, wherein the first connecting rod is arranged to be movable along a first direction and wherein the first rotatable part comprises a first crank pin adapted to slide in an elongated opening of the first connecting rod, so as to translate a rotating motion of the first rotatable part to a reciprocating motion of the first cutting tool.

3. The hand-held motor-driven cutting device according to claim 1, wherein the force limiting element at least reduces the reciprocating motion of the first cutting tool when the transmitted force applied to the first cutting tool reaches the predetermined force level.

4. The hand-held motor-driven cutting device according to claim 3, wherein the force limiting element permits the motor and the first rotatable part to continue to rotate in case the first cutting tool is blocked.

5. The hand-held motor-driven cutting device according to claim 1, wherein the force limiting element comprises a resilient element.

6. The hand-held motor-driven cutting device according to claim 5, wherein the resilient element comprises a pre-tensioned spring element.

7. The hand-held motor-driven cutting device according to claim 6, wherein the force limiting element is adapted to have an engaged state and a disengaged state.

8. The hand-held motor-driven cutting device according to claim 1, wherein the force limiting element is arranged between the second end of the first connecting rod and the first cutting tool.

9. The hand-held motor-driven cutting device according to claim 1, wherein the force limiting element permits the first connecting point to move in a radial direction of the first rotatable part such that a stroke of the first connecting rod is adapted to be dynamically altered to prevent the transmitted force applied to the first cutting tool from exceeding a predetermined force level.

10. The hand-held motor-driven cutting device according to claim 1, wherein the hand-held motor-driven cutting device comprises a second cutting tool cooperating with the first cutting tool.

11. The hand-held motor-driven cutting device according to claim 10, wherein the hand-held motor-driven cutting device comprises a second transmission arranged to translate a rotating motion to a reciprocating motion of the second cutting tool.

12. The hand-held motor-driven cutting device according to claim 11, wherein the second transmission comprises:
a second connecting rod with a first end and a second end, wherein the first end is eccentrically connected to the first rotatable part at a second connecting point of the first rotatable part and the second end is connected to the second cutting tool, and a further force limiting element arranged between the first rotatable part and the second cutting tool in order to prevent a transmitted force applied to the second cutting tool from exceeding a predetermined force level.

13. The hand-held motor-driven cutting device according to claim 11, wherein the second transmission comprises:
a second rotatable part, arranged to be driven by the motor, a second connecting rod with a first end and a second end, wherein the first end is eccentrically connected to the second rotatable part at a second connecting point of the second rotatable part and the second end is connected to the second cutting tool, and a further force limiting element arranged between the second rotatable part and the second cutting tool in order to prevent a transmitted force applied to the second cutting tool from exceeding a predetermined force level.

14. The hand-held motor-driven cutting device according to claim 1, wherein the hand-held motor-driven cutting device is a hand-held hedge trimmer.

15. A method of transmitting momentum in a hand-held motor-driven cutting device comprising;
supplying a rotary motion from a motor to a first rotatable part,
translating the rotary motion of the first rotatable part to a reciprocating motion of a first cutting tool utilizing a first transmission comprising a first connecting rod with a first end and a second end, wherein the first end is eccentrically connected to the first rotatable part at a first connection point of the first rotatable part and the second end is connected to the first cutting tool, and
preventing a transmitted force applied to the first cutting tool from exceeding a predetermined force level utilizing a force limiting element arranged between the first rotatable part and the first cutting tool.

16. The method of transmitting momentum in a hand-held motor-driven cutting device according to claim 15, comprising;
limiting the transmitted force to the first cutting tool utilizing the force limiting element arranged between the second end of the first connecting rod and the first cutting tool.

17. The method of transmitting momentum in a hand-held motor-driven cutting device according to claim 15, comprising;
limiting the transmitted force to the first cutting tool utilizing the force limiting element arranged between the first rotatable part and the first end of the first connecting rod.

18. The method of transmitting momentum in a hand-held motor-driven cutting device according to claim 17, comprising;
limiting the transmitted force to the first cutting tool by permitting the first eccentric connection point to move in a radial direction of the first rotatable part.
